(19) United States
(12) Patent Application Publication
(10) Pub. No.: US 2026/0002789 A1
(43) Pub. Date: Jan. 1, 2026

(54) SYSTEM FOR OFFROAD TRAVEL PATH ANALYSIS

(71) Applicant: FCA US LLC, Auburn Hills, MI (US)

(72) Inventors: Michael A.M. Bork, Auburn Hills, MI (US); Nicholas A Durham, Auburn Hills, MI (US)

(21) Appl. No.: 18/758,460

(22) Filed: Jun. 28, 2024

(51) Int. Cl. G01C 21/36; G01C 21/34

(52) U.S. Cl. CPC G01C 21/3632; G01C 21/3453

(57) ABSTRACT

A method for displaying travel path graphics in a vehicle, includes determining multiple travel path options, analyzing each of the travel path options with respect to at least one difference in a vertical dimension along each of the travel path options, and providing a recommended travel path to a driver of the vehicle.

### FIELD

The present disclosure relates to a system for analyzing travel path options, such as for offroad driving.

### BACKGROUND

Some vehicles include back-up cameras that show an area behind a vehicle when the vehicle is in reverse gear, to help a driver operate the vehicle in reverse. The camera image is provided on a dashboard or instrument panel display of the vehicle, below a vehicle and a graphic to indicate the vehicle path of travel is sometimes provided, and is curved to reflect a steering angle of the vehicle and the path the vehicle will take at a given steering angle. Among other things, the indicated path is not analyzed and no recommendation is provided as to the best path or whether any path includes an obstacle over which the vehicle cannot pass or by which the vehicle might be damaged or compromised.

### SUMMARY

In at least some implementations, a method for displaying travel path graphics in a vehicle, includes determining multiple travel path options, analyzing each of the travel path options with respect to at least one difference in a vertical dimension along each of the travel path options, and providing a recommended travel path to a driver of the vehicle.

In at least some implementations, the vertical dimension is the height of at least one feature within the travel path options.

In at least some implementations, the vertical dimension is a difference in height of two front wheels of the vehicle at one or more locations in each of the travel path options.

In at least some implementations, the recommended travel path is one of the travel path options that has the least variance in the vertical dimension. In at least some implementations, the variance in the vertical dimension is evaluated for the path to be taken by each of two front wheels of the vehicle.

In at least some implementations, in the analyzing step, each of the travel path options is analyzed with regard to a maximum height of any feature within each of the travel path options. In at least some implementations, the threshold for the maximum height is based at least in part on a predetermined ground clearance of the vehicle.

In at least some implementations, in the analyzing step, each of the travel path options is analyzed with regard to a threshold relating to a maximum difference in height between two front wheels of the vehicle at any point along each of the travel path options.

In at least some implementations, the vertical dimension is determined for terrain features along each of the travel path options.

In at least some implementations, information relating to the terrain features is obtained from one or more of a camera, radar sensor or lidar sensor.

In at least some implementations, the method also includes determining if any of the travel path options is impassable by comparing the vertical dimensions of features along each of the travel path options against one or more thresholds. In at least some implementations, the one or more thresholds includes one or both of a maximum size threshold and a threshold for a maximum difference in height between two front wheels of the vehicle. In at least some implementations, the method also includes providing a notice in the vehicle when the vehicle is determined to be traveling on a travel path that has been determined to be impassable.

In at least some implementations, the step of providing a recommended travel path is accomplished by providing graphics representing the recommended travel path on a display. In at least some implementations, the method also includes determining a viewing angle of a driver and wherein the position of the graphics on the display is determined as a function of the viewing angle.

In at least some implementations, a system used to analyze travel paths and display travel path graphics in a vehicle, includes one or more vehicle sensors, a control system in communication with the one or more vehicle sensors, and having a processor and memory with programming to:
determine multiple travel path options;
analyze each of the travel path options with respect to at least one difference in a vertical dimension along each of the travel path options; and
provide on a display in the vehicle a recommended travel.

In at least some implementations, the one or more vehicle sensors includes at least one terrain sensor capable of determining a vertical height of features and obstacles in an area of the vehicle. In at least some implementations, the at least one terrain sensor includes one or more of a camera, radar device or lidar device.

In at least some implementations, the system includes a driver sensor that is communicated with the control system to permit determination of a viewing angle of a driver of the vehicle relative to the display, and wherein the recommended travel path is represented by one or more graphics shown on the display, and the location of the one or more graphics relative to the display is adjusted as a function of the viewing angle.

In at least some implementations, in the analyzing step, each of the travel path options is analyzed with regard to one or more of a threshold for a maximum height of any feature within each of the travel path options, or a threshold relating to a maximum difference in height between two front wheels of the vehicle at any point along each of the travel path options.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a front view of a vehicle;

FIG. 2 is a diagrammatic top view of a vehicle showing a vehicle control system;

FIG. 3 is a diagrammatic view of the control system;

FIG. 4 is a view of a vehicle display showing a recommended travel path;

FIG. 5 is a graph of obstacle or feature height relative to the left and right wheel paths of the vehicle along the path of FIG. 4;

FIG. 6 is a view of the vehicle display showing a travel path having an intermediate or acceptable rating for vehicle travel;

FIG. 7 is a graph of obstacle or feature height relative to the left and right wheel paths of the vehicle along the path of FIG. 6;

FIG. 8 is a view of the vehicle display showing a travel path having a low rating for vehicle travel;

FIG. 9 is a graph of obstacle or feature height relative to the left and right wheel paths of the vehicle along the path of FIG. 8; and

FIG. 10 is a flowchart of a method for determining one or more recommended travel paths.

### DETAILED DESCRIPTION

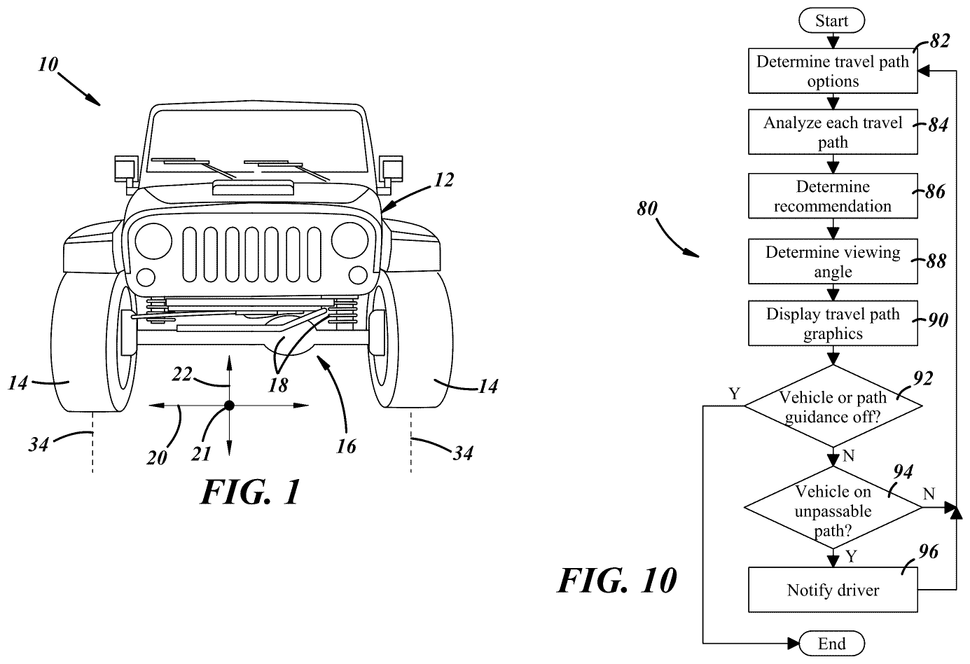

Referring in more detail to the drawings, FIG. 1 illustrates the front of a vehicle 10 having a body 12 and multiple wheels 14 coupled to the body 12 by a vehicle suspension 16 having various suspension components 18 as is known. Two front wheels 14 are shown in FIG. 1 and they are spaced apart horizontally, sometimes called a cross-car direction, extending between driver and passenger sides of the vehicle 10, and shown by arrow 20. The front of the vehicle 10 leads the rear of the vehicle 10 in a fore-aft direction 21 extending into/out of the page in FIG. 1, and the body 12 is suspended off a ground surface by the wheels 14 and vehicle suspension 16, in a vertical direction shown by arrow 22, which is parallel to the direction of gravity when the vehicle 10 is on a flat, level road oriented perpendicular to gravity.

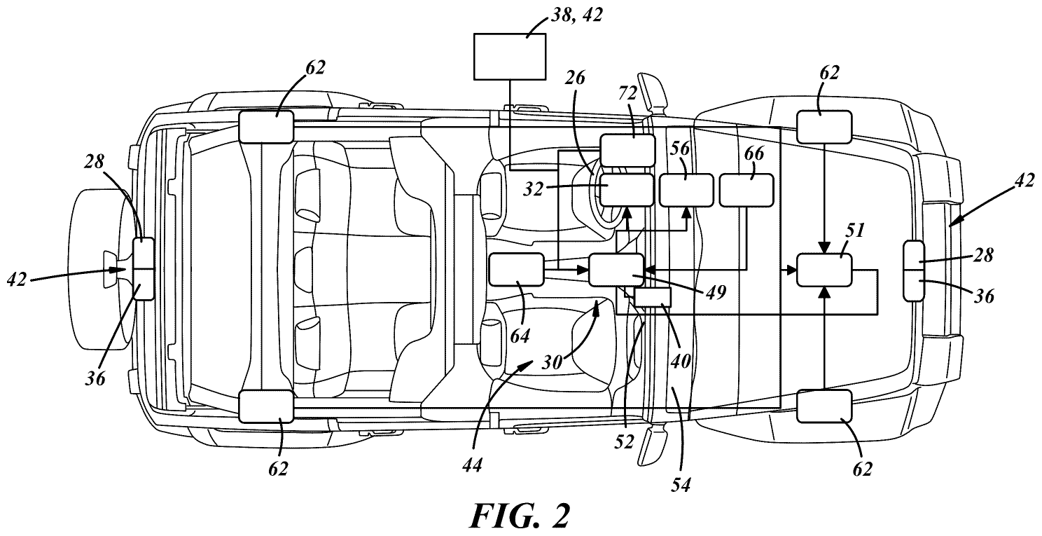

As shown in FIG. 2, the vehicle 10 may also include a steering input, such as a steering wheel 26, a camera 28, a control system 30, and a display 32. The steering input is any device by which a driver may command a change in the steering angle of the wheels 14 to turn the vehicle 10. The steering angle changes as the wheels 14 are rotated about a vertical axis 34 (FIG. 1).

The camera 28 is carried by the vehicle body 12 and has a lens with a viewing angle that includes an area to be traversed by the vehicle 10. When the vehicle 10 is moving in the forward direction, a forward-facing camera 28 can be used to view, sense or display the terrain in front of the vehicle 10. When the vehicle 10 is moving in reverse, that is in the rearward direction, a rearward-facing camera 28 can be used to view, sense or display the terrain at the rear or behind the vehicle 10. So the vehicle 10 may have one or more cameras, as desired, to show one or more areas of the environment in which the vehicle 10 is located.

To further sense or determine the terrain in the area of the vehicle 10, the vehicle 10 may include object detection sensors 36 such as, but not limited to, RADAR, LIDAR, ultrasonic, and other sensors 36 that may emit a detection output (e.g. light or sound waves) and be responsive to detection inputs (e.g. reflected light or sound waves) to determine the presence of objects in the path of the emission(s), and which may also be responsive to changes in the grade or inclination of the terrain ahead. The camera(s) 28 also can be considered to be object detection sensors as image data can be used to detect and locate objects. Still further, other data sources 38 may be remote from the vehicle 10 and available to the control system 30 and provide information about the terrain in the area of the vehicle 10, such as GPS and map data which may include the elevation, altitude and/or relative grade of the portion of a road, trail or other surface on which the vehicle 10 is travelling. The remote data sources 38 may be communicated with the vehicle 10 in any suitable manner, such as via a cellular or other wireless network and via a communications device 40 (e.g. telematics unit) of the vehicle 10. The cameras 28, object detection sensors 36 and remote data sources 38 may be collectively referred to herein, for convenience, as terrain sensors 42.

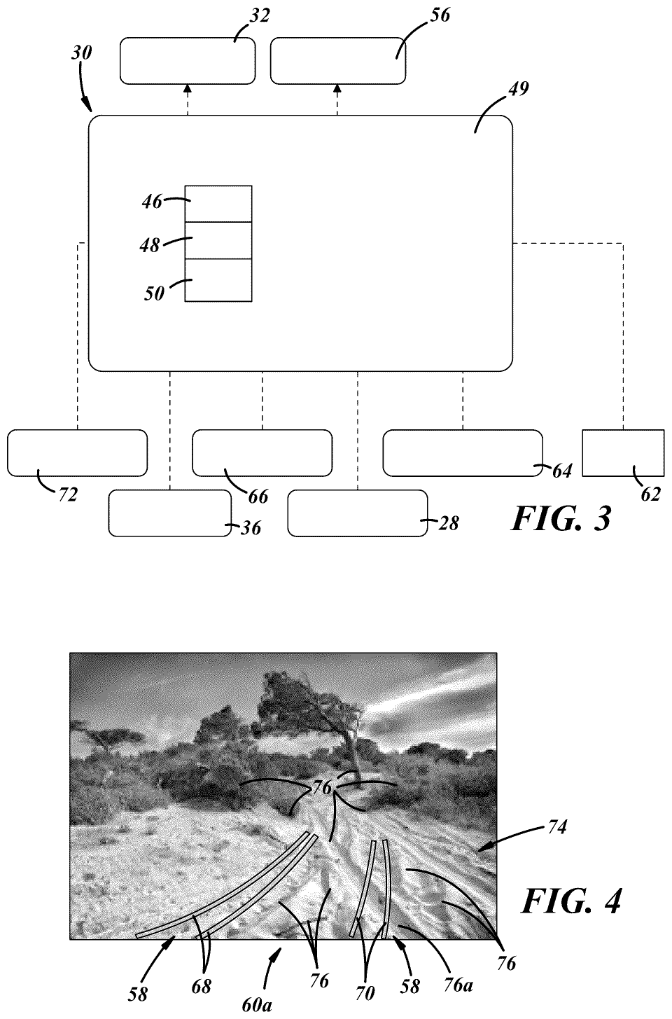

The display 32 may be carried by the vehicle body 12, such as within a passenger compartment 44 of the vehicle 10, and may be coupled to the cameras 28 to provide a view of the area to be traversed by the vehicle 10. The camera 28 and display 32 may be coupled to the control system 30 which may include, as shown in FIG. 3, a processor 46 and memory 48 that includes executable programs 50 or instructions. The display 32, processor 46 and memory 48 may be of suitable types and such components in vehicles are well-known and will not be further described herein.

To perform the functions and desired processing set forth herein, as well as the computations therefore, the control system 30 may include, but is not limited to, one or more controller(s), control unit(s), processor(s), computer(s), DSP(s), memory, storage, register(s), timing, interrupt(s) (generally referred to by reference numeral 46), communication interface(s), and input/output signal interfaces, and the like, as well as combinations comprising at least one of the foregoing. For example, the control system 30 may include input signal processing and filtering to enable accurate sampling and conversion or acquisitions of such signals from communications interfaces and sensors. As used herein the terms control system 30 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The control system 30 may be distributed among different vehicle modules, such as an infotainment system control module 49, suspension control module 51, engine control module or unit, powertrain control module, transmission control module, and the like, if desired.

The term “memory” 48 or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory 48 can store an operating system and/or instructions/programs 50 executable by a processor or controller or the like to enable control or allocate resources of a computing device.

As shown in FIG. 1, the display 32 may be part of a vehicle Human-Machine Interface, such as an infotainment system and may be located on or near a vehicle dashboard/instrument panel 52 (FIG. 1). Such displays may be called “heads-down” displays because they require a driver to lower their viewing angle from looking outward through a windshield 54 downward and within the vehicle 10 to see the display. The display may also or instead be provided as a so-called heads-up display 56 (HUD) 56 that is provided (e.g. projected) on the windshield 54 of the vehicle 10.

With a heads-up display 56, the information displayed can be viewed by a driver along with the environment outside the vehicle 10 and in view through the windshield 54. In at least some implementations, the information on the heads-up display 56 may include one or more graphics 58 (FIGS. 4, 6 and 8) that indicate the path 60 the vehicle wheels 14 will take when passing over the terrain ahead. This may, for example, help a driver navigate obstacles or more uneven or difficult terrain such as may be encountered on a trail or other off-road driving.

To compute and display the wheel paths or vehicle travel path 60, multiple sensors may provide information to the control system 30. In addition to the terrain sensors or sources 42 noted previously, the vehicle 10 may include a suspension sensor 62 that is carried by a suspension component 18, a wheel 14 or the vehicle body 12. A separate suspension sensor 62 may be provided for one and up to each wheel 14 of the vehicle 10, as shown in FIG. 2, and are coupled to and provide an input signal to the control system 30 that is indicative of the vertical position of the suspension component/wheels 14. The vehicle 10 may further include an accelerometer 64, such as an inertial measurement unit (IMU). The IMU 64 can detect movements relating to the attitude or inclination (e.g. pitch, yaw and roll) of the vehicle 10 along several axes, and may be used with or separately from the suspension sensor(s) 62 to determine information about the slope of the ground on which the vehicle 10 is situated. The suspension sensor(s) 62 and IMU 64 or other accelerometers may also be considered to be terrain sensors 42.

As noted above, the system also includes a steering system including a steering wheel 26, and one or more steering sensors 66 that determine one or both of an intended steering angle for the vehicle 10, or an actual steering angle for the vehicle 10. The steering sensor(s) 66 may be coupled to any desired component of the steering system and also to the control system 30 to provide a steering angle input to the control system 30.

The control system 30 has inputs from both the terrain sensors/sources 42 and steering sensor(s) 66 which provide information regarding vehicle attitude/orientation and intended and/or actual steering angle. From that information, the control system 30 can determine the nature of the terrain/inclination the vehicle 10 is currently on, the nature of terrain/inclination ahead of the vehicle 10, objects, obstructions or obstacles, and the intended path of travel for the vehicle 10. The control system 30 can then provide to the display to, based on these inputs, graphics depicting or representing the path 60 that one or more wheels 14 will take with continued travel and based on the current steering angle.

This may be shown on the display overlaid on an image provided by the camera 28. For example, when the vehicle 10 is traveling forward, the view captured by a forward-facing camera may be shown on the display 32, 56, and one or more of: a first graphic 68 (which may include one or more lines or polygons or other shapes) may be shown on the display that is indicative of the forward path of the front left wheel 14; and a second graphic 70 (which may include one or more lines or polygons or other shapes) may be shown on the display that is indicative of the forward path of the front right wheel 14. In at least some implementations, the first and second graphics 68, 70 may be elongated straight or curved lines or polygons laid out along the camera view, or in the case of a heads-up display 56, the graphics may be provided on the windshield 54 to match up with the terrain ahead of the vehicle 10, and need not be overlaid on an image/video stream from the camera 28 (e.g. augmented reality view that includes graphics 58 overlaid on the windshield and aligned with the driver's view of the environment), but the HUD could include an image from the camera and the graphics 58, if desired (e.g. the display would be similar to that of the heads-down or dashboard display).

Further, in the case of a heads-up display 56 (HUD), the control system 30 may also determine the viewing angle of a driver of the vehicle 10. The viewing angle of the driver may be determined from a driver sensor 72, such as a driver monitoring camera, that has a field of view that includes the drivers face. From analysis of the output of the driver sensor 72, the position of one or both of the driver's eyes (3D position, e.g. vertical, horizontal and distance from the windshield 54) can be determined and thus the angle at which the driver can view the HUD 56 can be determined. With the viewing angle and the terrain information, the path of travel 60 can be more accurately positioned relative to the actual environment ahead of the vehicle 10 so that the indicated travel path graphics 68, 70 can be overlayed in a realistic position on the windshield 54 as viewed by the driver and not floating too far above the path ahead, or located too low relative to the path. For example, if the vehicle 10 is inclined upwardly, with the front of the vehicle 10 aimed or oriented higher than the ground ahead of the vehicle 10 (e.g. the area ahead of the vehicle 10 that aligns with the travel path to be displayed), the travel path graphics may be displayed lower on the HUD to more closely align with the ground ahead, and vice versa. Similarly, to match or align with the environment in front of the vehicle, a driver having eyes located relatively higher in the vehicle may need the graphics 68, 70 to be displayed higher on the windshield of HUD than would a driver having eyes located lower.

FIGS. 4, 6 and 8 illustrate an off-road, unpaved path or area 74 in front of the vehicle 10 and having various features or obstacles 76, some of which may be impassable and some of which may be passable. Impassable features or obstacles 76 are those beyond one or more thresholds for size, steepness/grade or the like and generally include obstacles that the vehicle 10 cannot climb onto or pass over, or that the vehicle 10 cannot pass over safely or reliably. For example, the obstacle/features 76 might have a surface facing the vehicle 10 that is too high and steep for the vehicle 10 to pass over, and may include some of the bushes and trees shown on either side of the path. Impassable obstacles may be natural or man-made and may include walls, boulders, drop-offs (larger declines), mounds or piles of material, severe ruts, and the like. Passable objects may also be natural or man-made and generally include objects that the vehicle 10 can pass over or otherwise navigate. Examples include, but are not limited to, rocks or boulders, stumps, roots, tree limbs, ruts, curbs and small hills of dirt (e.g. below a threshold for grade or height or other size) or piles of material.

From information provided by the terrain sensors 42, the control system 30 can analyze and rate various possible directions or paths of travel for the vehicle 10. Based upon certain thresholds for terrain severity, the travel paths can be rated to determine one or more recommended or best travel path(s), as well as travel paths that are acceptable in that the vehicle 10 can safely pass through the path, and travel paths that are not recommended, for example because the vehicle 10 cannot safely pass the area via such path(s), or the path(s) lead to an area from which there is no recommended or acceptable path.

In rating the one or more travel paths, the system may evaluate all features or obstacles detected by the camera and other object detection sensors (e.g. Radar, Lidar). The system may take into account one or more vehicle characteristics such as, but not limited to, vehicle width, spacing between wheels 14, wheel size (e.g. width and diameter of the wheels 14), height of a front fascia or bumper, or other forward component of the vehicle 10, and the ride height of the vehicle 10 which may relate to the maximum ground clearance (e.g. distance between the bottom of the vehicle body 12 (or a component carried by the vehicle body 12) and the ground, which may differ in different orientations of the vehicle 10 and depending upon suspension component travel/movement and the like). In an example vehicle having a skid plate defining part or all of a bottom of the vehicle, the ground clearance may be defined by the skid plate, or a plane including a lowest part of the skid plate or other component.

In at least some implementations, the control system 30 may include programming 50 that analyzes information about the area in front of the vehicle 10, for example, with regard to features and obstacles 76 detected in the area. The system 30 may seek a path that satisfies one or more thresholds for severity that are set as a function of one or more vehicle characteristics, such as those noted above. In at least some implementations, the system determines variances in vertical dimensions or height of features, and may take into account the shape or slope of the features, with regard to the surface of the feature facing the vehicle 10 and which the vehicle 10 must pass over where features having more gradual slopes or certain shapes are more easily passed over than other features. The thresholds may include a maximum size threshold relating to a maximum height and/or the slope or shape of the features 76 (e.g. change in vertical height along the feature or obstacle), with features beyond the maximum size threshold being deemed to be unpassable. Paths including an impassable feature are not recommended paths, and the system may notify the driver and provide guidance to one or more acceptable paths to help the driver avoid heading down paths that are determined to not be passable.

Further, in at least some implementations, for the various paths that may be taken by the vehicle 10, the system may determine a rating based at least in part on the changes in elevation or vertical dimension, called herein AZ where Z is a notation for height or vertical direction, of features 76 that the vehicle 10 must pass over in that path. The rating may be done as a function of one or more thresholds. For example, the further a feature is from the maximum size threshold, or other size/shape thresholds, the better the rating is for that feature. In this way, the path having the least variance in height among all features in the path, i.e. the lowest AZ, can be given the highest or best rating and be deemed the best or recommended path.

For example, a maximum height threshold may be set and this may be independent or dependent upon the shape or slope of the surface of the feature or object facing the vehicle 10. The maximum height threshold may be set as a function of the ground clearance of the vehicle 10 and/or the ability of the vehicle 10 to move on or over obstacles of various size, such as with a Jeep™ or similar vehicle with off-road capabilities, which may be a function of, for example, wheel size, suspension capabilities and the like, and which may be predetermined. An obstacle or feature with a greater height than the vehicle ground clearance might be passable if the surface facing the vehicle 10 and initially engaged by the vehicle 10 is of a slope or shape that a vehicle wheel 14 can ride up and over the obstacle. The system may seek a path that provides the smallest changes in vertical displacement for both the left and right front wheels 14, or both. Further, a threshold may be set for a maximum differential in height between the left and right wheels, where such differences cause the vehicle 10 to tilt to one side or the other. A first path having a smaller differential in height between the left and right wheels than will be encountered in a second path can be given a better or higher rating than the second path. A path having at least part with a differential between the left and right wheels that is greater than a corresponding threshold can be given a low or unpassable rating.

In use, the height of the vehicle skid plate plane would be known, and to the IMU 64 and/or suspension sensors 62, the orientation of that plane would also be known to the control system. Depending on the terrain, the system could be setup to choose between the largest possible AZ between the skid plate plane and an obstacle, or perhaps an optimal solution that also satisfies safe vehicle dynamics (roll, pitch, articulation, etc.). In some situations, the system the system could determine that raising the skid plate plane by putting the vehicle wheels/tires on an obstacle with a large height (Z-dimension relative to the ground) can be beneficial compared to a travel path in which the center of the vehicle (skid plate plane) would become stuck or “turtled” on the taller obstacle. In at least some implementations, the system may consider at least three parameters, including: 1) the distance between the skid plate plane and the tallest obstacle in a path; 2) the distance between the top of that obstacle and the ground (e.g. the height or Z-dimension of the obstacle; and 3) the distance between the skid plate plane and the ground (e.g. the height of the skid plate plane, and perhaps the orientation/angle thereof as determined by sensors 62 and/or 64). From these parameters, it can be determined if a travel path is passable, and also relative ratings for the travel path options.

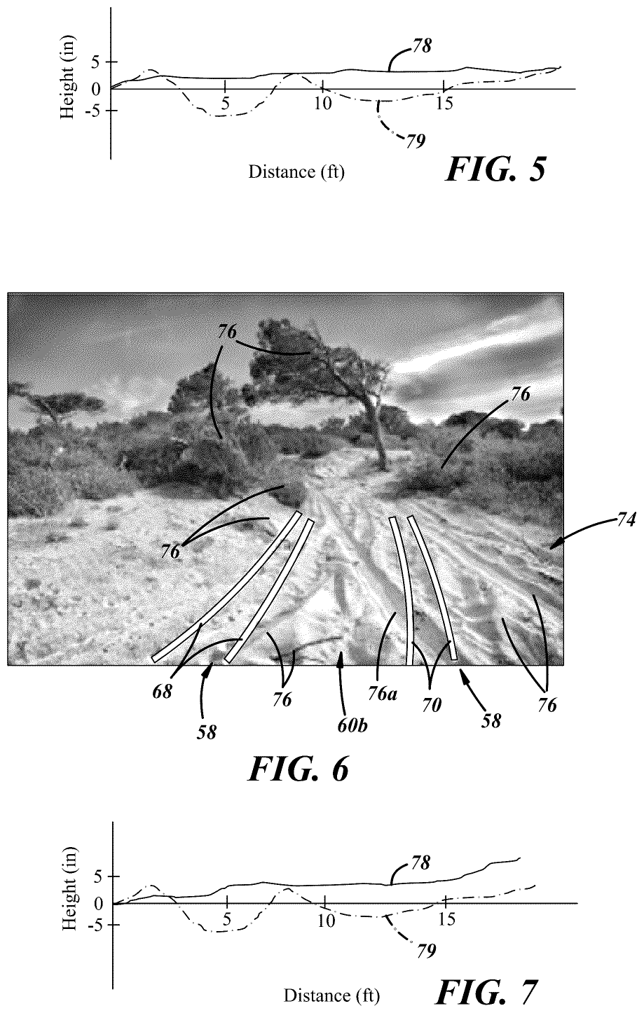

FIGS. 4, 6 and 8 illustrate three travel path options 60a, 60b and 60c, respectively. FIG. 4 illustrates a first travel path 60a for the vehicle 10, including graphics 58 for projected wheel paths 68, 70, and FIG. 5 illustrates the change in height (AZ) along that path. In this example, the AZ is shown for both the left front wheel (shown by line 78) and the right front wheel (shown by dashed line 79), but the system may use more locations along the path (e.g. to determine any unpassable obstacles between the wheels) or a single AZ calculation which may be an average of all features at a certain distance from the vehicle 10, or the greatest height feature in the path at a certain distance, by way of non-limiting examples. In this way, the system may look in three dimensions with an X direction being a cross-car direction (shown by arrow 20 in FIG. 2) between the opposite sides of the vehicle 10, a Y direction being a fore-aft direction and extending in the direction of travel (shown by point 21 in FIG. 2), and the Z direction being the vertical direction or height dimension as noted (shown by arrow 22 in FIG. 2). In this way, the distance (Y) to a feature, the location of the feature in the X or cross-car dimension and the height of the feature in the Z or vertical dimension (e.g. average height, maximum height, etc) can be determined for use in rating the travel path options.

In the example path 60a of FIGS. 4 and 5, the left wheel 14 moves along a slight incline but overall has littler variation in height along the projected length of the path. The right wheel 14 initially goes up over the near side of a rut 76a then down into the rut and over the far side of the rut and then down into a small depression beyond the rut before moving gradually uphill toward the end of the projected path length. None of the inclines or declines are beyond a threshold, for example threshold(s) for obstacle size or variance in height between the wheels 14 at a point along the path, and this path 60a is rated relatively high or well as the vehicle 10 can easily pass over the terrain along this path 60a.

FIG. 6 illustrates a second travel path 60b for the vehicle 10, including graphics 58 for projected wheel paths 68, 70, and FIG. 7 illustrates the change in height (AZ) along that second travel path. The AZ for the right wheel 14 in the second travel path 60b is similar to that in the first travel path 60a, and a similar rating may be given for both paths with respect to the projected path for the right wheel 14. In the second path 60b, the left wheel 14 will traverse similar terrain having similar ΔZ as in the first path 60a, but the area of the second travel path 60b at the end of the graphic for the left wheel 68 has a somewhat larger incline. This incline provides a height difference between the left and right wheels 14 that is larger than in the first travel path 60a but the incline is of a height that is passable by the vehicle 10. In this example, while both the first and second travel paths 60a, 60b are acceptable/passable by the vehicle 10, the first travel path 60a is preferred over the second travel path 60b and is given a better rating. The system may then provide a recommendation to the user to drive along the first travel path 60a.

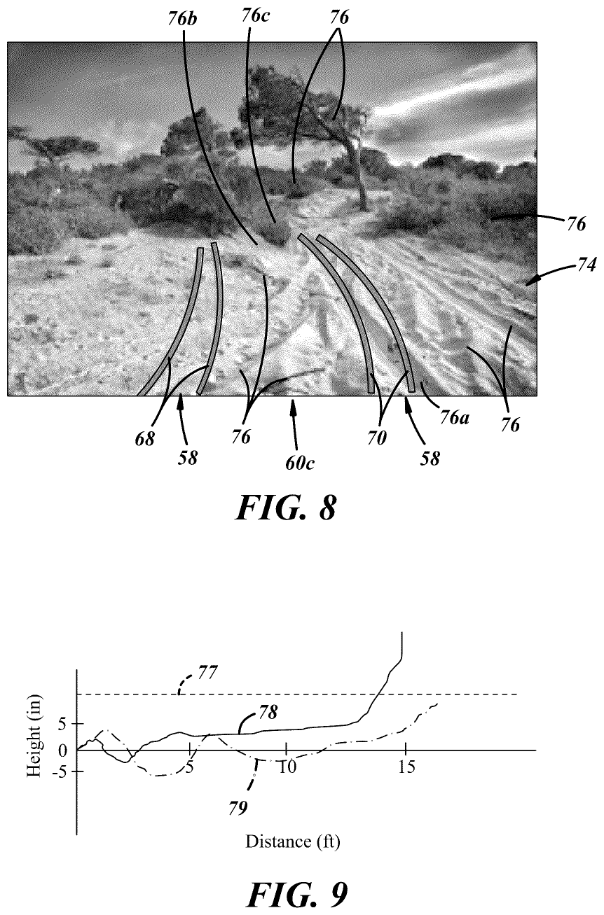

FIG. 8 illustrates a third travel path 60c for the vehicle 10 and FIG. 9 illustrates the change in height (AZ) along that third travel path 60c. Here, the path 60c leads to a larger incline 76b and a bush 76c on top of the incline that define features or obstacles 76 that are beyond our outside of the maximum size threshold, illustrated by line 77 in FIG. 9. Because the vehicle 10 is unlikely to be able to pass through the terrain along this path, the third travel path 60c is not recommended, and the system may alert a user with a message, graphic or other notification (audio or visual) if the user proceeds to guide the vehicle along the third travel path 60c.

In rating one or more travel path options 60a-c, the difference in wheel height (Z) for a left side wheel 14 and a right side wheel 14, at various distances (Y) from the vehicle 10 along various travel paths, can be determined. The difference in height of a single wheel 14 (e.g. change in height) due to that wheel 14 moving over different features or obstacles 76, as the vehicle 10 moves in the Y direction, can be determined. And the height of various features and obstacles between the wheels 14 (in the X direction) can be determined.

The control system 30 may utilize a method 80 to determine a travel path 60 to display, and where to display the travel or wheel path 60 relative to a driver's viewing angle, such as the method set forth in FIG. 10. The method 80 starts at step 82 in which the travel path options are determined, which may be done by analysis of the information from the terrain sensors, and with certain parameters regarding a minimum variation in path that may be set to reduce the number of paths determined and that need to be analyzed. In step 84, the travel path determined in step 82 are analyzed, for example with regard to AZ for one or more features along the path as noted above. Each path may be rated, or in some implementations, the paths may be more simply determined to be passage or unpassable which is a form of rating and which may be done in view of one or more thresholds. In step 86, a travel path recommendation is determined by the system.

In step 88, the driver's viewing angle may be determined, such as by use of the data from the driver sensor 72 (e.g. camera), so that the graphics may be provided on a heads-up display in a manner that aligns with the terrain outside of the vehicle 10. In step 90, the travel path recommendation is provided to the driver, which may be done in any suitable manner. For example, graphics indicating the preferred travel path may be shown on a display, or otherwise communicated to the driver. In one example, the driver may be visually or audibly informed how to steer to and/or along the travel path that is recommended. When travel path graphics 68, 70 are displayed on the HUD 56 and/or other displays 32 within the vehicle 10, they may be located on the display(s) as a function of the driver's viewing angle. In this way, a realistic and informational travel path 60 can be shown to a driver, that better blends in with the actual path ahead of the vehicle 10 as viewed through the windshield 54 and through the portion of the windshield 54 including the HUD 56, or better comports with an image of the ground ahead that is provided by a camera and shown on a display 32. Next, in step 92, it may be determined if the vehicle 10 is turned off or if the travel path recommendation feature has been disabled or turned off by a user. If so, the method may end.

In at least some implementations, the driver is not required to follow the recommended travel path. In step 94, it is determined if the current/actual travel path for the vehicle 10, based at least in part on the current steering angle, leads to an unpassable feature or obstacle, or is otherwise rated or determined to be unpassable (e.g. has too great of a height variance between left and right wheels at some point in the path). If so, the driver is notified in step 96. This may be done, for example, with a message or graphic on a display, or by audible message. If the current vehicle travel path is determined to be passable in step 94, the method may return to step 82 to reassess the travel path and provide recommendations to the driver as the vehicle 10 progresses along the terrain. The method may also loop back to step 82 after the driver is notified to perform the method again. This may be done continuously or at defined intervals, and the interval(s) may be selected as a function of the speed of the vehicle 10 (e.g. longer intervals at slower speeds and vice versa).

In offroad driving, the terrain is often not uniform or well defined. Further, seasonal weather conditions can change the characteristics of the path, such as by rain washing out certain areas, making it difficult or dangerous to drive in the same manner year over year. The systems and methods taught herein user sensory inputs and a control system 30 programmed with a best path or acceptable path prediction model to calculate the best path and/or acceptable paths of travel based on the projected wheel paths. This may be done as a function of reviewing changes in verticality or elevation and seek a path having the smallest changes in elevation (AZ) for both the left wheel and right wheel. The AZ threshold or other thresholds or ratings can be impacted by the pose or attitude of the vehicle 10, so if the vehicle body 12 is at an increased pitch or roll angle, the threshold(s) or rating criteria can be altered to provide a modified recommendation. The pose or attitude can be determined, for example, by one or more suspension sensors or accelerometers, like the onboard inertial measurement unit (IMU). The recommendations for the path of travel can be presented as projections of the wheel tracks out in front of the vehicle 10. In one example, the recommended or best path may be shown with green graphics, yellow graphics may denote one or more acceptable but the less-than-optimal or preferred path(s), and red graphics may denote the least preferred or an impassable path to be avoided. The classifications may be based on a tolerance band or tolerance for AZ, maximum size threshold(s), and the like, and can vary per vehicle model and trim level (e.g. vehicle capabilities).

What is claimed is:

1. A method for analyzing travel path options for a vehicle, comprising:
determining multiple travel path options;
analyzing each of the travel path options with respect to at least one difference in a vertical dimension along each of the travel path options; and
providing a recommended travel path to a driver of the vehicle.

2. The method of claim 1 wherein the vertical dimension is the height of at least one feature within the travel path options.

3. The method of claim 1 wherein the vertical dimension is a difference in height of two front wheels of the vehicle at one or more locations in each of the travel path options.

4. The method of claim 1 wherein the recommended travel path is one of the travel path options that has the least variance in the vertical dimension.

5. The method of claim 4 wherein the variance in the vertical dimension is evaluated for the path to be taken by each of two front wheels of the vehicle.

6. The method of claim 1 wherein, in the analyzing step, each of the travel path options is analyzed with regard to a maximum height of any feature within each of the travel path options.

7. The method of claim 6 wherein the threshold for the maximum height is based at least in part on a predetermined ground clearance of the vehicle.

8. The method of claim 1 wherein, in the analyzing step, each of the travel path options is analyzed with regard to a threshold relating to a maximum difference in height between two front wheels of the vehicle at any point along each of the travel path options.

9. The method of claim 1 wherein the vertical dimension is determined for terrain features along each of the travel path options.

10. The method of claim 1 wherein information relating to the terrain features is obtained from one or more of a camera, radar sensor or lidar sensor.

11. The method of claim 1 which also includes determining if any of the travel path options is impassable by comparing the vertical dimensions of features along each of the travel path options against one or more thresholds.

12. The method of claim 11 wherein the one or more thresholds includes one or both of a maximum size threshold and a threshold for a maximum difference in height between two front wheels of the vehicle.

13. The method of claim 11 which also includes providing a notice in the vehicle when the vehicle is determined to be traveling on a travel path that has been determined to be impassable.

14. The method of claim 1 the step of providing a recommended travel path is accomplished by providing graphics representing the recommended travel path on a display.

15. The method of claim 13 which also includes determining a viewing angle of a driver and wherein the position of the graphics on the display is determined as a function of the viewing angle.

16. A system to analyze travel paths and display travel path graphics in a vehicle, comprising:
one or more vehicle sensors;
a control system in communication with the one or more vehicle sensors, and having a processor and memory with programming to:
determine multiple travel path options;
analyze each of the travel path options with respect to at least one difference in a vertical dimension along each of the travel path options; and
provide on a display in the vehicle a recommended travel.

17. The system of claim 16 wherein the one or more vehicle sensors includes at least one terrain sensor capable of determining a vertical height of features and obstacles in an area of the vehicle.

18. The system of claim 17 wherein the at least one terrain sensor includes one or more of a camera, radar device or lidar device.

19. The system of claim 16 which includes a driver sensor that is communicated with the control system to permit determination of a viewing angle of a driver of the vehicle relative to the display, and wherein the recommended travel path is represented by one or more graphics shown on the display, and the location of the one or more graphics relative to the display is adjusted as a function of the viewing angle.

20. The system of claim 16 wherein, in the analyzing step, each of the travel path options is analyzed with regard to one or more of a threshold for a maximum height of any feature within each of the travel path options, or a threshold relating to a maximum difference in height between two front wheels of the vehicle at any point along each of the travel path options.
